(19) United States
(12) Patent Application Publication
(10) Pub. No.: US 2015/0372581 A1
(43) Pub. Date: Dec. 24, 2015

(54) Kinetic energy system utilizing multi-size multi-use high speed rotating flywheel

(71) Applicant: Christopher Michael Morris, Portland, OR (US)

(72) Inventor: Christopher Michael Morris, Portland, OR (US)

(21) Appl. No.: 14/120,728

(22) Filed: Jun. 20, 2014

(51) Int. Cl. H02K 47/00; H02K 7/02

(52) U.S. Cl. CPC H02K 47/00; H02K 7/02; Y10S 74/09; H02K 53/00

(57) ABSTRACT

Processes used in the past were hazardous due to the material with which they were constructed, the design, and the location of the flywheel used on the device. In addition, the energy was inefficiently drawn from the flywheel which caused them to be replaced by fuel driven engines which emitted CO/2 and other greenhouse gases. My invention will create kinetic energy with zero greenhouse gases and all safety issues are remedied by high grade materials and new safety specifications. My invention is to turn a flywheel containing more kinetic energy than required by an electrical generator to produce power. The flywheel will be driven by an external energy source and, by overcoming the required kinetic energy of the electrical generator with the kinetic energy of the flywheel spinning at a high R.P.M., it will create kinetic energy.

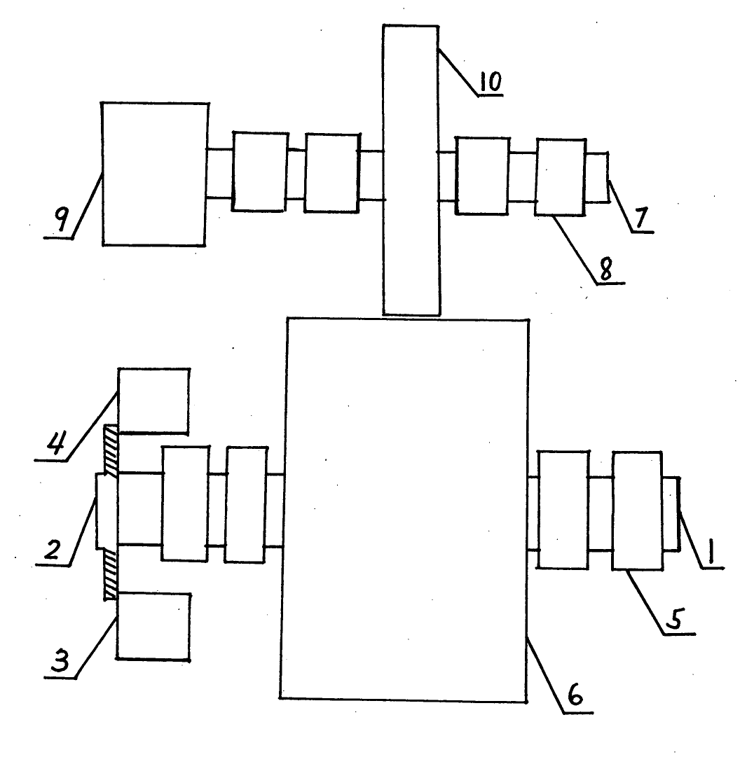

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not applicable

### BACKGROUND OF INVENTION

The field of endeavor to which this invention pertains is the generation of electricity and/or power, from watt size to gigawatt size.

Problems involved with past and presently used method of electrical power generation have been well documented in the media.

Hydroelectric power: The turbines or impellers are responsible for killing unknown trillions of small migrating fish and stop others from migrating at all and have taken up millions of miles of land that at one time was someone's home or grave.

Wind Turbine Power: Wind is not dependable and only produces in a small window of operational speed; the turbine must be taken offline during higher or lower wind speeds, and the output is only small megawatts per acre. They also kill many birds, bugs and insects that we need to pollenate our food chain. Very high, hard and dangerous to work on, imagine in winter at sea! Ocean units are greatly affected by previously listed concerns, in addition to hurricane seasons, tsunamis and other ocean anomalies.

Coal and Gas burning plants: No matter how well controlled and highly filtered, these put out the largest amounts of greenhouse gases and particulate matter into our atmosphere.

Biomass plants: These put out some greenhouse gases, but are a factor of our waste materials.

Solar Power: Is inefficient and only produces small amounts of electricity. The black panels generate a lot of heat back into the atmosphere that is just as bad as the greenhouse gases we are trying to stop any way. As far as the heat being generated by the large reflecting type of solar heating systems, these are even worse.

Nuclear power plants: Do I really need to list the number of things That are so wrong with this type of power system?

### BRIEF SUMMARY OF THE INVENTION

A general law of motion states that a large mass will stay in motion unless acted upon by an equal or greater opposite reaction. Utilizing a set of starter motors attached to the starting plate on the shaft of a flywheel, the kinetic energy system will rotate at a high rate of speed with an outer drive wheel maintaining the R.P.M.'s of the main spinning flywheel by the use of an electric motor on the drive wheel The input power will be added to the outer diameter of the flywheel, and the output energy will be drawn from the center of the shaft, providing a constant supply of kinetic energy which will turn an electric generator.

The advantages of the kinetic energy system will solve the previously existing hazards or problems listed in the Background section by overcoming all of those adverse impacts on the environment. There will be no turbines or impellers which kill or deter migrating fish, no waste of large tracts of land, no killing of birds, bees or other insects, no hazardous work conditions due to height or weather.

Instead of a low energy output per acre, it can produce an average of 625 megawatts per acre, be 100% green with zero carbon emissions or particulates, causing no heat to be generated back into the atmosphere, no transportation or storage problems which cause fires, explosions or spills, no time lost due to the need for long cooling or reheating processes.

The kinetic energy system will be self-energized and housed in a closed self-contained, environmentally controlled room or building on the ground or underground. This will prevent environmentally caused impacts on the system itself because, if located in areas prone to natural disasters such as hurricane, tornado, earthquake, volcanic ash, flood, drought or ice, the buildings can be adapted and strengthened to withstand catastrophic events.

### BRIEF DESCRIPTION OF THE SEVERAL VIEWS OF THE DRAWING

Page 1/1 shows a side view of the kinetic energy system.

### REFERENCE NUMERALS

1 Main flywheel support shaft
2 Main flywheel starter plate
3 Low speed starter motor
4 High speed starter motor
5 Main flywheel support shaft bearing
6 Main kinetic energy flywheel
7 Drive wheel support shaft
8 Drive wheel support shaft bearing
9 External input drive electric motor
10 External input drive wheel

### DETAILED DESCRIPTION OF THE INVENTION

The old method of applying power to the center of a flywheel and using the energy from the outside of a flywheel worked okay back in the 1800's, but there has been no further progress throughout the ensuing years.

For references to old flywheel uses, please see the following:

www.youtube.com/watch?v=WEZjknUrUpw.

### www.SRHF.ORG/Antique-Farm-Engines-at-FHF.pdf

en.wikipedia.org/wiki/Hit-and-miss_engine-54k-

My method represents a different way of generating energy by applying external energy to the outside of the flywheel and drawing energy from the center of the flywheel, which makes it harder to drain the kinetic energy stored in the flywheel. My flywheel will spin at higher R.P.M.'s and produce higher amounts of useable kinetic energy at a constant rate, twenty-four hours per day, seven days per week, three hundred sixty-five days per year without catastrophic failure.

New technology has created so many advances that, for an example, instead of using cast iron as in the past, high quality rolled steel is available for use today.

In my system, the Main kinetic energy flywheel 6 will hang from the Main flywheel support shaft 1 and the Main flywheel support shaft bearing 5. The Main kinetic energy flywheel 6 will be put into motion, first by using the Low speed starter motor 3 located on the Main flywheel starter plate 2. Once the peak running speed has been reached, the High speed starter motor 4, located on the Main flywheel starter plate 2, will be used. When this peak running speed has been reached, the External input drive wheel 10, supported by the Drive wheel support shaft 7 and Drive wheel support shaft bearing 8, will be engaged, driven by the External input drive electric motor 9 to reach and maintain the required R.P.M.'s.

The size of the flywheel is determined by the amount of energy that is required by the systems to which it is being connected. In order to operate, a generator or engine requires a certain amount of pound-feet of torque. So as not to be slowed down by the kinetic energy being drawn from it, the flywheel spinning at its required R.P.M.s, will generate at least twice or more of the required pound-feet of torque in order to operate systems of any size to which it is attached. As an example: a 25 megawatt generator requires 35,290 H.P. to turn at 720 R.P.M.s (257,431.30 pound-feet of torque). My 15 foot diameter flywheel at 8 inches thick, weighing 57,734 pounds, spinning at 1,500 R.P.M.s will produce123,668 H.P. (433,004 feet-pounds of torque). It will require a gear ratio of 2.5:1 reduction which will end up with a total of five times the generator's required feet-pounds of torque.

In attaching the various components of the kinetic energy system to one another, or the entire system to a framed unit, the attachments can be made with fasteners such as nuts, bolts, screws, set screws, sheer pins, end caps, and it can be welded, riveted, epoxied or by using any other attachment methods known in the art (not shown).

1. All possible various sizes, shapes, materials, methods of spinning, multiple power sources for turning, types of vehicles and mechanical equipment that can be powered by the kinetic energy system, and locations for use:
All possible sizes of the flywheel
Such as thickness from 1 in. to 72 in., diameter from 1 ft. to 100 ft.
All possible shapes of the flywheel
Such as round, spherical or any other round spinning shape
All possible materials from which the system can be made with an average weight of more than 0.1505 lbs. per cubic inch
Such as, but not limited to aluminum, metal alloys, steel, copper or any other material known to be used in any related field of work
All possible attachments used to spin the flywheel
Such as, but not limited to belts, chains, gears, levers, magnets, pulleys, rollers, springs, wheels or any other possible method to connect the drive source to the flywheel
All possible power sources used for turning the flywheel
Such as, but not limited to animal, human, electric motor, hydro, wind, steam, tidal, fossil fuel or any other power generating system used in the past or currently being used
All possible types of vehicles and mechanical equipment that can be run by the kinetic energy system
Such as, but not limited to cars, trucks, motorhomes, weaving machines, cotton gins, ventilation systems, elevators
All possible locations where the kinetic energy system can be used
Such as, but not limited to on the ground on trains, underground, on ships at sea, on aircraft, in space on the moon or Mars.
